(19) United States
(12) Patent Application Publication
(10) Pub. No.: US 2009/0300674 A1
(43) Pub. Date: Dec. 3, 2009

(54) METHOD, SYSTEM AND APPARATUS FOR DELIVERING ENHANCED PROGRAMMING INFORMATION

(75) Inventors: Peter Werner Ratsch, Toronto (CA); Maarten Boudewijn Heilbron, Toronto (CA); Alexander Joseph Du, Newmarket (CA)

Correspondence Address: SMART & BIGGAR, 1000 DE LA GAUCHETIERE ST. W., SUITE 3300, MONTREAL, QC, H3B 4W5, CA

(73) Assignee: BCE Inc

(21) Appl. No.: 12/063,197

(22) PCT Filed: Apr. 19, 2006
(86) PCT No.: PCT/CA2006/000626

§ 371 Date: Feb. 7, 2008

(51) Int. Cl. H04N 7/025; H04N 5/445; H04N 7/173

(52) U.S. Cl. 725/32; 725/43; 725/134; 725/116

(57) ABSTRACT

A method, system and apparatus for delivering enhanced programming information. In some non-limiting embodiments the method comprises obtaining channel grid information for identifying a programming event, the programming event being associated to an occurrence interval. The method further comprises receiving a dynamic program description associated with the programming event. Receiving of the dynamic program description is executed during the occurrence interval associated to the programming event. The channel grid information is then augmented with the dynamic program description. The disclosed method, system and apparatus enable the subscriber to ascertain the current status of the programming event occurring on one or more channels to potentially enable the subscriber to make a more informed decision as to which specific programming event to select for viewing.

### FIELD OF THE INVENTION

This invention relates generally to video delivery systems and more specifically to a method, system and apparatus for delivering enhanced programming information.

### BACKGROUND OF THE INVENTION

In the early days of television, viewers relied on flipping through channels to find a program that they wished to watch. This solution was satisfactory when viewers were offered a limited number of television channels to select from. With developments in television delivery systems, however viewers now face an ever increasing choice of channels and programs. Television systems nowadays typically include an Electronic Programming Guide (EPG) to enable viewers to browse a myriad of programming information to select a particular programming event for viewing. The EPG generally provides a title of a particular programming event, time, duration, as well as the associated channel line-up information. Some of the more sophisticated EPGs also provide a brief description of the programming event, including synopsis, actors, guests, etc. In most cases, the viewer can retrieve this additional information by clicking a button (such as a dedicated button marked “INFO”) on a remote control.

One of the inconveniences associated with EPGs currently available is that they provide a static description of programming events, i.e. descriptions that have been pre-provisioned and downloaded as part of the EPG file. In some cases, the information would have been provisioned more than a month prior to the viewer actually using the information in the EPG to make his or her selection. Thus, when a viewer browses programming information associated with multiple simultaneous programming events (such as sporting events, news programs, music performances, award ceremonies, etc.), she or he has to rely on a static and mostly high level synopsis of the event to make her or his decision. Therefore, the viewer is not always able to make an informed decision about which programming event to select.

There is a need in the art for an improved delivery of programming information that would enhance viewers' ability to more accurately select a particular programming event among multiple simultaneously occurring programming events.

### SUMMARY OF THE INVENTION

A first broad aspect of the present invention seeks to provide a method for delivering enhanced programming information. The method comprises obtaining channel grid information for identifying a programming event, the programming event associated to an occurrence interval; receiving a dynamic program description associated with the programming event, the receiving occurring during said occurrence interval associated to the programming event; augmenting the channel grid information with the dynamic program description.

A second broad aspect of the present invention seeks to provide a method for enabling delivery of enhanced programming information. The method comprises transmitting channel grid information to a subscriber premises device for identifying a programming event; transmitting a dynamic program description associated with the programming event to the subscriber premises device during an occurrence interval associated to the programming event; the dynamic program description enabling the subscriber premises device to augment the channel grid information with the dynamic program description.

A third broad aspect of the present invention seeks to provide a system for delivery of enhanced programming information. The system comprises at least one subscriber premises device. The system further comprises a content provider operable to: transmit channel grid information to the at least one subscriber premises device for identifying a programming event; transmit during an occurrence interval associated to the programming event a dynamic program description associated with the programming event to the at least one subscriber premises device, wherein responsive to receiving the dynamic program description, the at least one subscriber premises device is operable to augment the channel grid information with the dynamic program description.

A fourth broad aspect of the present invention seeks to provide a customer premises apparatus. The customer premises apparatus comprises: a first interface for receiving a signal from a content provider; a second interface for conveying an output signal derived from the received signal to an audio-video output device; and a processing module coupled to the first and second interfaces. The processing apparatus operable to: obtain via the first interface channel grid information for identifying a programming event; receive via the first interface during an occurrence interval associated to the programming event a dynamic program description associated with the programming event; augment the channel grid information with the dynamic program description.

Another broad aspect of the present invention seeks to provide an apparatus for enabling delivery of enhanced programming information. The apparatus comprises: means for transmitting channel grid information to a subscriber premises device for identifying a programming event; means for transmitting a dynamic program description associated to the programming event to the subscriber premises device during an occurrence interval associated to the programming event; the dynamic program description enabling the subscriber premises device to augment the channel grid information with the dynamic program description.

These and other aspects and features of the present invention will now become apparent to those skilled in the art upon review of the following description of specific embodiments of the invention in conjunction with the accompanying drawings.

### BRIEF DESCRIPTION OF THE DRAWINGS

Non-limiting embodiments of the present invention are described with reference to the following figures, in which:

FIG. 1 is a schematic diagram representing a video delivery system according to a non-limiting embodiment of the invention;

FIGS. 2A-2C are schematic diagrams representing enhanced programming information screens according to various non-limiting embodiments of the invention;

FIGS. 3A-3D are schematic diagrams representing enhanced programming information screens according to other non-limiting embodiments of the invention;

FIG. 4 is a schematic representation of channel grid information maintained by a subscriber premises device of the video delivery system of FIG. 1;

FIG. 5 is a schematic representation of a delivery component that can be used for generating enhanced programming information in some non-limiting embodiments of the present invention;

FIG. 6 depicts a method for conveying enhanced programming information according to a non-limiting embodiment of the invention.

It is to be expressly understood that the description and drawings are only for the purpose of illustration of certain embodiments of the invention and are an aid for understanding. They are not intended to be a definition of the limits of the invention.

### DETAILED DESCRIPTION OF THE EMBODIMENTS

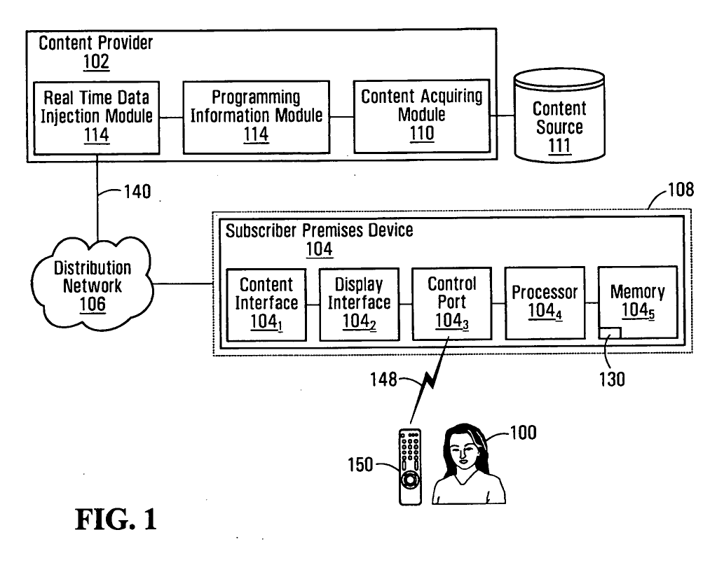

With reference to FIG. 1, there is shown an architecture in which a subscriber to a television service (hereinafter referred to as a subscriber 100) receives television programming from a content provider 102 over a distribution network 106. The specific television programming that the subscriber 100 wishes to be able to view can be selected by the subscriber 100 from a set of channel packages, feature packages and the like that may be offered by the content provider 102. A programming information module 112 at the content provider 102 may store an association between the subscriber 100 and data representative of the selected television programming and feature packages for the subscriber 100. To that extent, it will be apparent to those skilled in the art that the programming information module 112 is operable to perform conditional access functionality. The conditional access functionality is known to those skilled in the art and, therefore, will not be described in further detail.

The content provider 102 can further comprise a content acquiring module 110 and a real time data injection module 114. The content acquiring module 110 can be responsible for acquiring different types of content from a content source 111. Generally speaking, two example types of content acquired by the content acquiring module 110 are (i) programming content (or, in other words, the content used for distributing one or more channel packages) and (ii) feature content. The feature content can be used for delivering various feature packages, such as but not limited to electronic programming guide information, interactive applications, weather reports, stock quotes and the like. In the non-limiting example of the feature package comprising an electronic programming guide, the content source 111 can comprise a provider of EPG data, such as “TV Guide” (see http://online.tvguide.com).

As will be described in greater detail herein below, the content acquiring module 110 can also acquire content required for delivering an enhanced electronic programming guide. For now, suffice it to say that in these non-limiting embodiments the content source 111 can further comprise a content aggregator (such as but not limited to sports content aggregator), an event broadcaster and the like.

The real time injection module 114 is operable to transmit one or more channels 140 via the distribution network 106, the one or more channels 140 enabling the content provider 102 to deliver the aforementioned channel packages and feature packages to the subscribers (such as the subscriber 100). To that extent, the one or more channels 140 can convey signals representing one or more programming events, as well as signals representing one or more feature packages (such as interactive applications and the like). Naturally, the type of the real time injection module 114 will depend on the type of the distribution network 106. Suitable types of distribution network 106 that enable the above-mentioned viewing possibilities include satellite, a data network adapted for transmitting video (generally referred herein below as IPTV), xDSL and cable systems. In a non-limiting example of the distribution network 106 comprising a data network adapted for video distribution, the real time data injection module 114 is operable to digitize the one or more channels 140 into packets suitable for distribution over the data network. In another non-limiting example of the distribution network 106 comprising a satellite broadcasting network, the real time date injection module 114 is operable to broadcasts the one or more channels 140 via a broadcast carousel as is well known to those of skill in the art.

In some non-limiting embodiments of the present invention, the architecture depicted in FIG. 1 can further comprise a communication network (not depicted), which can be different from the distribution network 106. The communication network can comprise any suitable type of connection between the content provider 102 (for example, the programming information module 112 or the real time injection module 114) and the subscriber premises device 104, such as a dial-up connection, a broadband connection, a wireless connection and the like.

In each of these types of distribution networks 106, the subscriber 100 can be provided with a subscriber premises device 104 installed at subscriber premises 108. The subscriber premises device 104 is commonly referred to as a set-top box and can be generally implemented in a receiver device, modem, residential gateway, network interface device and the like. A non limiting example of the set-top box is manufactured by EchoStar of 9601 South Meridian Blvd., Englewood, Colo., USA. The subscriber premises device 104 is generally connected to an audio-video output device (not depicted) which can be generally embodied as a television set, a computer monitor and the like.

A non-limiting example subscriber premises device 104 can comprise a number of interfaces. Firstly, the subscriber premises device 104 can comprise a content interface 104, for receiving the one or more channels 140 from the content provider 102. The type of the content interface 104₁ depends on the nature of the distribution network 106. For example, in the case where the distribution network 106 is a satellite broadcasting network, the content interface 104₁ can comprise a reception device (such as a satellite dish, an antenna or the like, typically installed outside the subscriber's premises, such as on the side of a house or on the roof), as well as outside/inside wiring between the reception device and the remainder of the subscriber premises device 104. Alternatively, in the case where the distribution network 106 is a cable system, the content interface 104₁ can comprises a coaxial cable interface. Alternatively, in the case that the distribution network 106 is an IPTV-based network, the content interface 104₁ can comprise an Ethernet cable connection and can support various access technologies, such as DSL, cable, fiber-to-the-home and the like. In the case that the distribution network 106 is an xDSL network, the content interface 104₁ can comprise an xDSL modem.

In some non-limiting examples of the present invention, the content interface 104₁ can receive a signal from the aforementioned communication network, as well as transmit a return signal via the aforementioned communication network. The example signal can comprise the aforementioned feature content. The example return signal can comprise viewing statistics associated with the subscriber 100, orders for video-on-demand (VOD) movies and shows; and the like. Other variants are also within the scope of the embodiments of the present invention.

The subscriber premises device 104 can further comprise a display interface 104₂ for connecting to the above-mentioned audio-video output device for conveying to the display a signal representing the content of the one or more channels 140.

The subscriber premises device 104 can further comprise a control port 104₃ for receiving control signals 148 from a control device 150, such as a remote control or the like. It should be understood that the control port 104₃ can be adapted to receive control signals over infra-red waves, UHF, Bluetooth® or any other suitable transmission medium.

The subscriber premises device 104 can further comprise a processor 104₄ that can be used for controlling other components of the subscriber premises device 104 (such as the content interface 104₁, the display interface 104₂, the control port 104₃ as well as other components). The processor 104₄ can be implemented in software, hardware, control logic or a combination thereof. The processor 104₄ can access a memory 104₅ used for storing information, such as an interactive application (herein below referred to simply as an “EPG application”) used for conveying an enhanced electronic programming guide according to various embodiments of the present invention. The EPG application is generally depicted at 130. As will be appreciated by those of skill in the art, the EPG application 130 can be downloaded to the memory 104₅ upon occurrence of a specific event (for example when the subscriber premises device 104 is powered on), at a specific time (such as late at night), on-demand or at any other suitable time. It should be understood that any suitable type of the memory 104₅ can be used, such as but not limited to random-access memory. In alternative non-limiting embodiments, the EPG application 130 can be implemented in any suitable resident software application.

The subscriber premises device 104 can comprise a number of other interfaces and components, such interfaces being known to those skilled in the art and, as such, need not be described here in any detail. For instance, in some non-limiting embodiments of the present invention, the subscriber premises device 104 can comprise a second content interface (not depicted) operable to receive the aforementioned signal from the communication network. In the specific non-limiting example of the communication network comprising a dial-up connection, the second content interface can comprise an RJ-11 interface. In the specific non-limiting example of the communication network comprising a broadband connection, the second content interface can comprise an Ethernet interface.

Given the architecture of FIG. 1, it is possible to deliver the enhanced electronic programming guide according to embodiments of the present invention. For the purposes of the description presented herein below, a non-limiting example of the distribution network 106 comprising a satellite broadcasting network will be used. However, it should be clear that persons skilled in the art will be able to easily adapt these teachings to other types of distribution network 106. In the example embodiment described herein below, the enhanced electronic programming guide is compiled and conveyed by the aforementioned EPG application 130 that resides in the memory 104₅.

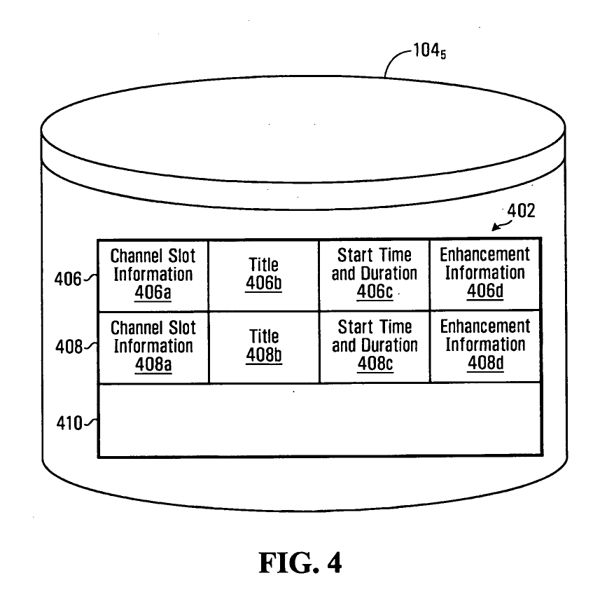

The EPG application 130 is operable to receive and store data representative of so-called “channel grid information”, such as a channel number, a start time and a duration (or any conceivable combination thereof) associated with a particular programming event. Reference is now made to FIG. 4 which schematically depicts data stored by the EPG application 130 in the memory 104₅. The EPG application 130 can maintain a table 402 that contains a number of records, such as records 406, 408 and 410, each of the records 406, 408 and 410 being maintained for respective programming events. An example record 406 can be maintained for the particular programming event (such as in a non-limiting example, a super giant slalom event at the Winter Olympic Games that occurs during a particular occurrence interval) and can contain several fields, such as:
channel slot information 406a (referred to herein below as CSI 406a) that can contain data that is generally indicative of the channel number of the channel on which the particular programming event occurs;
title 406b that can contain data that is generally indicative of the title associated with the particular programming event;
start time and duration 406c that can contain data that is generally indicative of the start time and duration of the particular programming event or, put another way, defining an occurrence interval for the particular programming event.

Data maintained in the CSI 406a, the title 406b and the start time and duration 406c, which can be collectively referred to as channel grid information, is received from the content provider 102. Specifically, this channel grid information is downloaded from the aforementioned content provider 102 into the memory 104₅ in advance, prior to the commencement of the occurrence interval of the programming event to which the channel grid information pertains. In some non-limiting embodiments of the present invention, the content provider 102 can transmit the channel grid information to the subscriber premises device 104 via the distribution network 106. In alternative non-limiting embodiments, the content provider 102 can transmit the channel grid information to the subscriber premises device 104 via the aforementioned communication network. The channel grid information can be transmitted by the content provider 102 to the subscriber premises device 104 a week in advance, two weeks in advance, 3 days in advance and the like. Data contained in these fields can be thought of as static information which generally does not change once it is downloaded to the memory 104₅. In other words, the channel grid information remains static and does not change once the occurrence interval associated to a particular programming event has commenced.

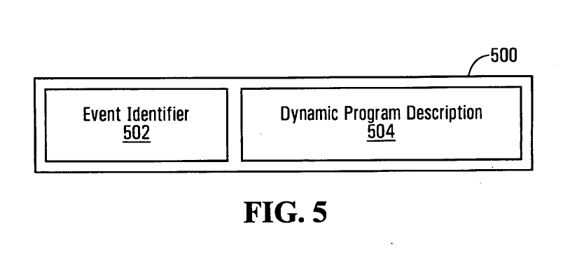

The record 405 can also maintain enhancement information 406d that can contain data that is used for compiling an enhanced portion of the enhanced electronic programming guide according to various embodiments of the present invention, as will be described in greater detail herein below. The enhancement information 406d contains data at least a portion of which can be thought of as dynamic or, in other words, data that can change during the occurrence interval of the particular programming event to which it pertains. How the information maintained in the enhancement information 406d is received and stored will now be described in greater detail with reference to FIG. 5.

In some non-limiting embodiments of the present invention, the channel grid information can further contain a so-called “static synopsis” (such as, a brief summary of the particular programming event, a list of actors, etc.) associated with the particular programming event. This static synopsis also does not change once the occurrence interval associated with the particular programming event has commenced. In some non-limiting embodiments of the present invention, the static synopsis can be stored in a dedicated field (not depicted) of the record 406. In alternative non-limiting embodiments of the present invention, the static synopsis can be stored in a potion of the enhancement information 406d. The synopsis can be downloaded together with the CSI 406a, the title 406b and the start time and duration 406c. In these non-limiting embodiments, the enhancement information 406d can comprise two logical portions—a first logical portion containing static information and a second logical portion containing dynamic program description.

FIG. 5 schematically depicts an enhancement token 500 according to one specific non-limiting embodiment of the invention. Generally speaking, the purpose of the enhancement token 500 is to convey data that can be used for generating the enhanced electronic programming guide according to various embodiments of the present invention. In some non-limiting embodiments, the enhancement token 500 can be generated by the programming information module 112 of the content provider 102. Data used for compiling the enhancement module 500 is obtained by the content acquiring module 110 from the content source 111. Consider the following example of the super giant slalom event in the Winter Olympic Games. The content source 111 can generate a number of indicators that are representative of a current competitor, the next competitor and the like that corresponds to the current status of a particular programming event. The content acquiring module 110 acquires these indicators and makes them available to the programming information module 112. The programming information module 112 generates a dynamic program description 504 based on one or more of these indicators. Generally speaking, the dynamic program description 504 contains an indication of a programming segment currently occurring in the programming event to which the enhancement token 500 pertains.

The programming information module 112 also assigns an event identifier 502 to the enhancement token 500. The function of the event identifier 502 is to uniquely identify a particular programming event to which a particular enhancement token 500 pertains. It will be recalled that the programming information module 112 has previously generated and transmitted the channel grid information associated with the particular programming event and, therefore, the programming information module 112 can conveniently generate the event identifier 502 that would uniquely identify the particular programming event by identifying a portion of the channel grid information.

The type of the event identifier 502 is not particularly limiting. In one non-limiting example, the event identifier 502 can contain an indication of the channel number maintained in the aforementioned CSI 406a of the record that is associated with the particular programming event (in this example scenario, the record 406). Put another way, the event identifier 502 contains an indication of the channel number on which the particular programming event to which the enhancement token 500 pertains occurs. In another non-limiting example, the event identifier 502 can contain an indication of the channel number maintained in the CSI 406a and an indication of the start time maintained in the aforementioned start time and duration 406c. In another non-limiting example, the event identifier 502 can contain any suitable identifier that would uniquely identify the channel number and/or start time information maintained in the CSI 406a and start time and duration 406c respectively. Other suitable types of identifiers include but are not limited to the title of the programming event, the title and occurrence interval combination to name just a few.

The programming information module 112 passes the enhancement token 500 to the real time data injection module 114 for distribution to the subscriber premises device 104. In some non-limiting embodiments of the present invention, the real time data injection module 114 can distribute the enhancement token 500 via the distribution network 106. How the real time injection module 114 distributes the enhancement token 500 is not particularly limiting and will depend on the type of the distribution network 106. In a non-limiting example of the distribution network 106 comprising a data network adapted for video distribution, the real time data injection module 114 is operable to digitize the enhancement token 500 into one or more packets suitable for distribution over the data network adapted for video distribution. In another non-limiting example of the distribution network 106 comprising a satellite broadcasting network, the real time data injection module 114 is operable to broadcasts the enhancement token 500 via a broadcast carousel as is well known to those of skill in the art. It should be noted that in alternative non-limiting embodiments, the programming information module 112 can transmit the enhancement token 500 to the to the subscriber premises device 104 via the aforementioned communication network (not depicted).

In other non-limiting embodiments of the present invention, rather than relying on indicators generated by the content source 111, a member of staff associated with the content provider 102 can generate the dynamic program description 504 by watching the programming event and inputting a description to be used for the dynamic program description 504 using a computing apparatus (not depicted) coupled to the programming information module 112. The programming information module 112 receives the input from the computing apparatus and creates the enhancement token 500 in substantially the same manner as described in the preceding paragraphs.

The subscriber premises device 104 can receive the enhancement token 500 via the content interface 104₁ and provide the received enhancement token 500 to the EPG application 130. The EPG application 130 receives the enhancement token 500 and retrieves the event identifier 502 and the dynamic program description 504 from the enhancement token 500. Equipped with the data contained in the event identifier 502, the EPG application 130 attempts to identify the particular programming event to which the enhancement token 500 pertains. Specifically, the EPG application 130 attempts to identify a record in the table 402 that contains data that matches the event identifier 502.

For the purposes of the non-limiting example presented herein, assume that the event identifier 502 contains a channel number that matches the content of the CSI 406a which would be indicative of the enhancement token 500 being pertinent to the particular programming event for which record 406 is maintained. Once a positive match is located, the EPG application 130 uploads the content of the dynamic program description 504 into the enhancement information 406d of the record 406.

It should be recalled that in some non-limiting embodiments, the enhancement information 406d can contain a portion associated with the static synopsis. In these non-limiting embodiments, the EPG application 130 can (i) delete the static synopsis portion from the enhancement information 406d and upload the dynamic program description 504 instead (or another words, substitute the static synopsis portion with the dynamic program description); or (ii) store the dynamic program description 504 in addition to the static synopsis portion already stored in the enhancement information 406d.

In case the EPG application 130 fails to locate a match within the table 402, it can execute an exception handling function, such as but not limited to ignoring the enhancement token 500.

Therefore, it will now be clear how the EPG application 130 generates the record 406 that generally contains channel grid information (such as static information maintained in the CSI 406a, title 406b, start time and duration 406c) and dynamic program description (such as data maintained in enhancement information 406d or in at least a portion thereof). In a specific non-limiting example described herein, the content of the record 406 can be as follows:

| | |
|---|---|
| CSI 406a | <channel><48> |
| Title 406b | <title><Winter Olympic Games. Super Giant Slalom> |
| Start time and | <start><14:00><duration><120> |
| duration 406c | |
| Enhancement | <dynamic program description><SCHIFFERER, |
| information 406d | Andreas> |

By the same token, the EPG application 130 generates the aforementioned record 408. The fields of the record 408 (i.e. CSI 408a, title 408b, start time and duration 408c and enhancement information 408d) can be substantially similar and be populated in substantially the same manner as the fields of the record 406 (i.e. CSI 406a, title 406b, start time and duration 406c and enhancement information 406d respectively). In a specific non-limiting example described herein, the content of the record 408 can be as follows:

| | |
|---|---|
| CSI 408a | <channel><50> |
| Title 408b | <title><National News> |
| Start time and | <start><14:00><duration><60> |
| duration 408c | |
| Enhancement | <dynamic program description><Latest news on |
| information 408d | murder investigation> |

The EPG application 130 can maintain a number of other records (generally depicted at 410), which can be generated in a substantially the same way as the record 406.

It should be understood that the enhancement information 408d can maintain any other suitable type of dynamic program description 504 which will naturally depend on the type of the programming event that it pertains to. For example, in a non-limiting embodiment where the programming event comprises a hockey game, the enhancement information 408d can maintain the following information:

| | |
|---|---|
| Enhancement | <dynamic program description><Toronto 0, |
| information 408d | Ottawa 4. Second period> |

In this non-limiting embodiment, the dynamic program description 504 denotes the current score and the current period occurring in the hockey game. Other suitable types of dynamic program description 504 will now become apparent to those of skill in the art.

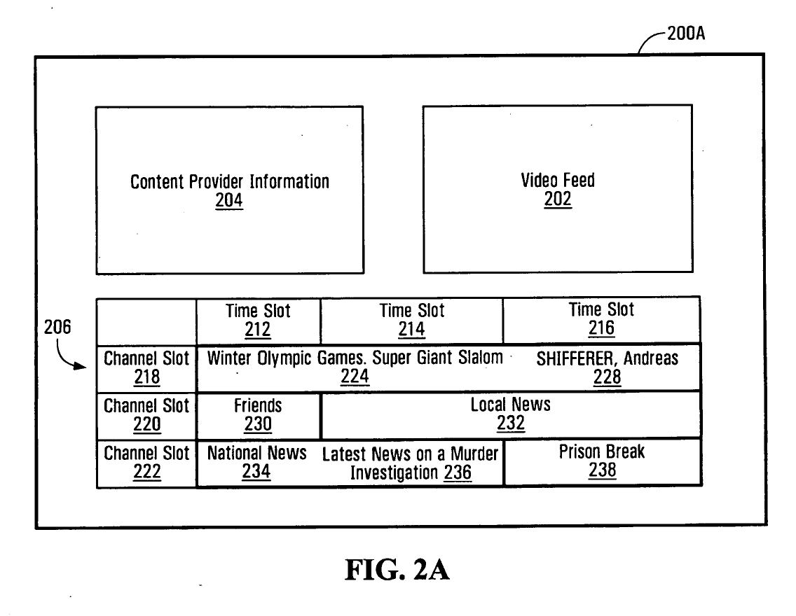

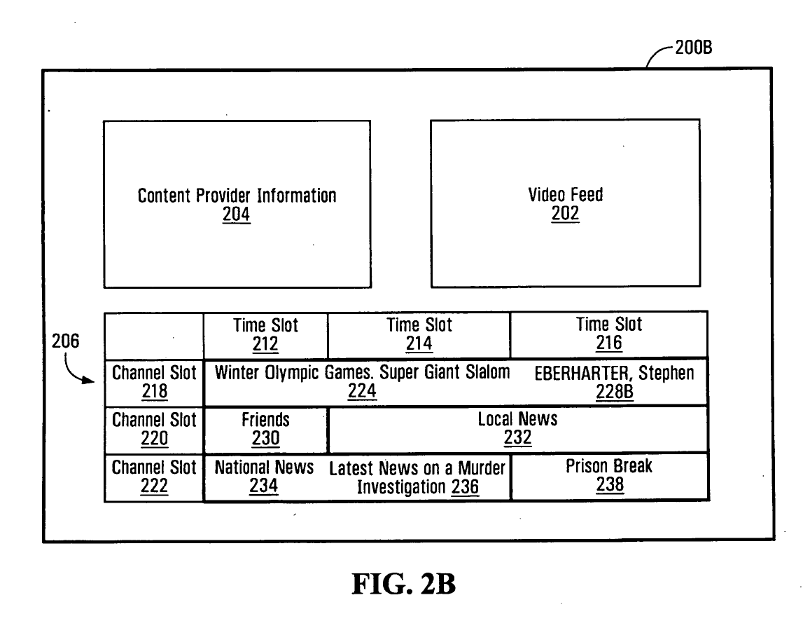

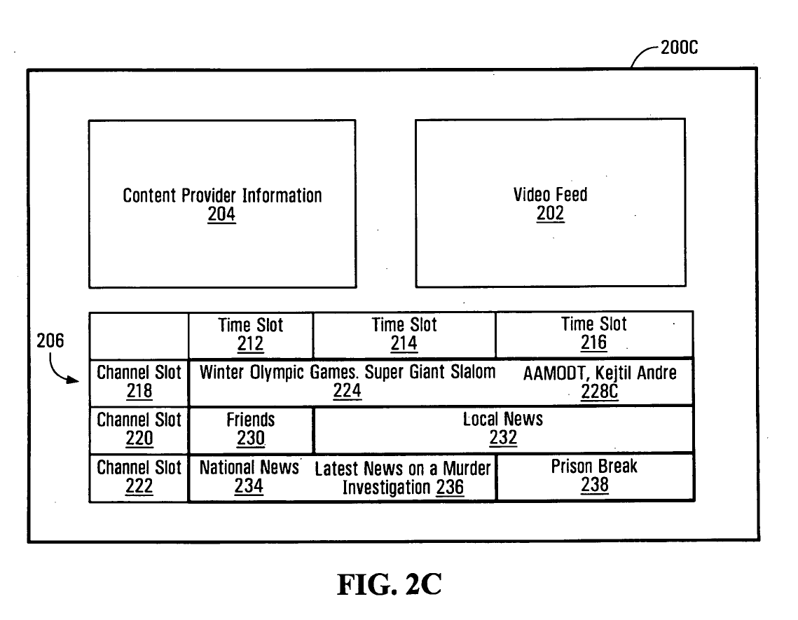

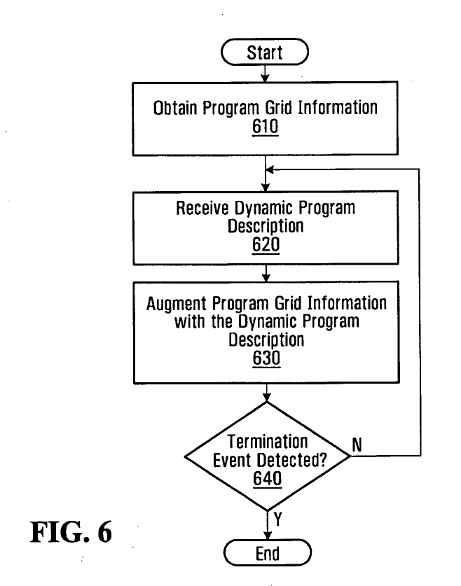

Given the content of the table 402 and, specifically the content of the enhancement information 406d, 408d, the EPG application 130 is operable to generate and convey to the subscriber 100 an enhanced electronic programming guide. With reference to FIGS. 2A-2C and FIG. 6, a method for generating the enhanced electronic programming guide according to a non-limiting embodiment of the present invention is now described in more detail. The method for generating the enhanced electronic programming guide can be conveniently executed by the EPG application 130, but this should not be construed as a limitation of the embodiments of the present invention. For instance, in some non-limiting embodiments of the present invention, the method can be executed by another component of the customer premises device 104, such as another EPG application, another software application executed by the processor 104₄ and the like.

### Step 610: Obtain Channel Grid Information

The aforementioned method begins at step 610 where the channel grid information is obtained. It will be recalled that the EPG application 130 receives the channel grid information from the content provider 102 and stores the received channel grid information in the aforementioned CSI 406a, the title 406b and the start time and duration 406c of the example record 406.
For the purposes of the description presented herein below, it is assumed that the EPG application 130 has populated the record 406 associated with a particular programming event with the aforementioned static data and stored the record 406 into the memory 104₅. It is also assumed here that the subscriber 100 has indicated his or her desire to view the enhanced electronic programming guide. How the subscriber 100 invokes the enhanced electronic programming guide is immaterial for the purposes of the embodiments of the present invention. In one specific non-limiting embodiment, the subscriber 100 may indicate his or her desire by clicking a button on the aforementioned control device 150, by scrolling through a menu of various EPG applications available (including the EPG application 130) and the like.
Upon receiving the indication of the subscriber's desire to view the enhanced electronic programming guide, the EPG application 130 generates an enhanced electronic programming guide screen generally depicted at 200A in FIG. 2A. The enhanced electronic programming guide screen 200A contains a video feed 202 portion that is dedicated to showing a reduced version of the video feed of the programming event from which the enhanced electronic programming guide was invoked or, in other words, the video feed viewed before invoking the enhanced electronic programming guide. How to generate such a reduced version of the video feed is well known to those of skill in the art and, as such, need not be discussed here.
The enhanced electronic programming guide screen 200A can further comprise a content provider information 204, which can contain data associated with the aforementioned content provider 102, such as but not limited to branding information (ex. logos, slogans, etc.), promotional messages, advertising messages and the like. This data associated with the content provider 102 can be retrieved from the memory 104₅, to which it has been either previously downloaded from the content provider 102 or hard coded by the content provider 102 before distributing the subscriber premises device 104 to the subscriber 100.
The EPG application 130 also generates basic channel grid information, generally depicted at 206. Generally speaking, the EPG application 130 generates a screen table that contains channel slot information (such as channel slots 218, 220 and 222) in the headers of the horizontal rows and time slot information (such as time slots 212, 214 and 216) in headers of the vertical columns. Naturally, the EPG application 130 can reverse the content of the headers for the columns and rows.
The data for the channel slots 218 and 222 can be conveniently obtained from the aforementioned channel slot information 406a and 408a respectively (the channel slot information 406a and 408a being maintained in the aforementioned table 402). The data for the channel slot 220 can be obtained from the respective record generally depicted at 410 in FIG. 4.
The data for generating cell content of the screen table associated with respective programming events of the basic programming grid information 206 can be obtained from the title 406b, 408b and start time and duration 406c, 408c. The process for generating content of the basic programming grid information 206 is well known in the art and, therefore, only an example for illustration purposes will be presented here.
Assume that the particular programming event occurs on a channel associated with a channel slot 218 (for example, channel “48”), has an occurrence interval associated with the time slots 212, 214 and 216 (for example, 90 minutes starting at 14:00) and a title comprising “Winter Olympic Games. Super Giant Slalom” 224, as would be maintained in the respective fields of the record 406 maintained in the aforementioned table 402. The EPG application 130 retrieves this information from the record 406 and generates an entry in the time slots 212, 214 and 216 for the channel slot 218 to depict “Winter Olympic Games. Super Giant Slalom” 224.
In the same manner, the EPG application 130 creates an entry for “Local News” 232 associated with the channel slot 220 and the time slots 214 and 216. An entry for “Friends” 230 associated with the channel slot 220 spans the time slot 212. An entry for “National News” 234 associated with the channel slot 222 spans the time slots 212 and 214. Finally, an entry for “Prison Break” 238 associated with the channel slot 222 spans time slot 216.
It should be noted that channel slots 218, 220 and 222 can be associated with numerically adjacent channels (such as channels 48, 49 and 50). Alternatively, channel slots 218, 220 and 222 can be associated with favourite channels (which could be numerically adjacent or numerically distributed) provisioned by the subscriber 100. In yet another alternative embodiment, channel slots 218, 220 and 222 can be associated with channels within a theme package (which could be numerically adjacent or numerically distributed), such as a sports package, a music package, a movies package and the like.
It will be recalled that in some non-limiting embodiments of the present invention, the static information (that can include the static synopsis and the like) can be stored in a portion of the enhancement information 406d (or a dedicated field or any other suitable field of the record 406). Provided that such a static synopsis has indeed been received and stored in the portion of the enhancement information 406d (or another suitable field), the EPG application 130 can further convey the static synopsis to the subscriber 100, if the subscriber 100 indicates his or her desire to view the static synopsis, for example by pressing a button on the control device 150 (for instance, an “INFO” button or the like).
It should now be clear that given the received channel grid information, the EPG application 130 can generate and convey to the subscriber 100 via the aforementioned audio-video output device the basic channel grid information 206, the video feed 202 and the content provider information 204, as well as the static synopsis associated with the particular programming event.

### Step 620: Receive Dynamic Program Description During an Occurrence Interval of the Programming Event

At this step, the EPG application 130 receives a dynamic program description associated with a programming event. It will be recalled that the content provider 102 can generate and distribute one or more enhancement tokens 500. Due to the very nature of the enhancement token 500, the enhancement token 500 is distributed while the programming event that it pertains to is broadcast. Put another way, the enhancement token 500 pertaining to a specific programming event is distributed during the occurrence interval of the specific programming event that it pertains to. For the purposes of the forthcoming discussion, assume that a start time associated with the time slot 212 has occurred. In other words, the Super Giant Slalom of the Winter Olympic Games is being broadcast on the channel associated with the channel slot 218, an episode of Friends is being broadcast on the channel associated with the channel slot 220 and the National News is being broadcast on the channel associated with the channel slot 222.
Assume that the EPG application 130 has received two enhancement tokens 500—an enhancement token 500A pertaining to the Winter Olympic Games and an enhancement token 500B pertaining to the National News. The enhancement token 500A has an event identifier 502A identifying the channel number associated with the channel on which the Winter Olympic Games are occurring (i.e. the channel number contained in the CSI 406a which in turn is used for generating the channel slot 218). In the specific non-limiting example described herein, the event identifier 502A contains “48”. The enhancement token 500A further contains a dynamic program description 504A containing “SHIFFERER, Andreas” 228, denoting the current competitor in the sporting event being broadcast on the channel associated with the channel slot 218.
In the same manner, the enhancement token 500B has an event identifier 502B identifying the channel number on which National News is occurring (i.e. the channel number contained in the CSI 408a which in turn is used to generate the channel slot 222). In the specific non-limiting example described herein, the event identifier 502B contains “50”. The enhancement token 500B further contains a dynamic program description 504B containing “Latest news on a murder investigation” 236, denoting the current news segment in the news program being broadcast on the channel associated with the channel slot 222.
It should now be clear that the dynamic program descriptions 504A, 504B contain information that represent content currently occurring in the respective programming events.
   Step 630: Augment the Channel Grid Information with the Dynamic Program Description
At this step, the EPG application 130 augments the channel grid information received in step 610 with the dynamic program description received in step 620.
Firstly, the EPG application 130 examines the content of the enhancement token 500A and retrieves the event identifier 502A and the dynamic program description 504A. It will be recalled that in this illustrative embodiment, the event identifier 502A contains a channel number indicative of the channel on which the particular programming event to which the enhancement token 500A pertains to occurs. Effectively, the identifier 502A contains the channel number maintained in the channel slot information 406a. Accordingly, when the EPG application 130 attempts to detect a record within table 402 that relates to the particular programming event which matches the event identifier 502A, it will conveniently be able to correlate the event identifier 502A to the record 406. The EPG application 130 then stores the content of the dynamic program description 504A in the enhancement information 406d.
Once the dynamic program description 504A has been stored in the enhancement information 406d, the EPG application 130 initiates a screen update function. Specifically, the EPG application 130 updates the entry “Winter Olympic Games. Super Giant Slalom” 224 in the enhanced electronic programming guide screen 200C with “SCHIFFERER, Andreas” 228. Effectively, the subscriber 100 browsing the enhanced electronic programming guide screen 200A will not only be able to ascertain the general nature of the programming event currently occurring (i.e. the Super Giant Slalom), but also be able to obtain a more detailed enhanced information representing what currently happening in the programming event (i.e. the current competitor, in this case “SCHIFFERER, Andreas” 228).
In the same manner, the EPG application 130 stores the content of the dynamic program description 504B in the enhancement information 408d. The EPG application 130 then initiates the screen update function to update the entry for “National News” 234 with “Latest news on murder investigation” 236. Effectively, the subscriber 100 browsing the enhanced electronic programming guide screen 200A will not only be able to ascertain the general nature of the programming event currently occurring (i.e. National News), but also be able to obtain a more detailed enhanced information representing what currently happening in the programming event (i.e. the particular news segment).

### Step 640: A Termination Event Detected?

At this step, the EPG application 130 attempts to detect a termination event. The type of the termination event is not particularly limiting and can be embodied in the subscriber 100 exiting the enhanced electronic programming guide by clicking an exit button on the aforementioned control device 150, the subscriber 100 switching off the customer premises device 104 and the like.
If the termination event is encountered (i.e. the “Yes” branch of step 640), the EPG application 130 terminates execution of the method. If, on the other hand, no termination event is encountered (i.e. the “No” branch of step 640), the EPG application 130 loops back to step 620 where it continues to wait for receipt of another dynamic program description 504 pertaining to the particular programming event.

### “No Trigger Loop” of the Method

For the purposes of the forthcoming discussion, assume that the content provider 102 has distributed an enhancement token 500C that also pertains to the Winter Olympic Games depicting the then current competitor in the Super Giant Slalom. Once the EPG application 130 receives the enhancement token 500C in step 620, it proceeds once again to step 630. The enhancement token 500C has an event identifier 502C containing the channel number associated with the channel on which the particular programming event to which it pertains occurs. Effectively, the event identifier 502C contains a channel number that points to the channel slot 218. The enhancement token 500C further comprises a dynamic program description 504C containing “EBERHARTER, Stephen” 228B, denoting the then current competitor in the sporting event being broadcast on the channel associated with the channel slot 218.
The EPG application 130 examines the content of the enhancement token 500C and retrieves the event identifier 502C and the dynamic program description 504C. It will be recalled that in the non-limiting example described herein, the event identifier 502C contains a channel number associated with the channel on which the particular programming event to which the enhancement token 500C pertains. Effectively, the identifier 502C contains the channel number maintained in the channel slot information 406a. Accordingly, when the EPG application 130 attempts to detect a record within table 402 that relates to the particular programming event which matches the event identifier 502C, it will conveniently be able to correlate the event identifier 502C to the record 406. The EPG application 130 also detects that the enhancement information 406d already contains dynamic program description and, therefore, deletes the content of the enhancement information 406d and stores the content of the dynamic program description 504C in the enhancement information 406d instead. Effectively, the EPG application 130 updates the content of the enhancement information 406d with the dynamic program description denoting the then current content of the particular programming event.
Once the dynamic program description 504C has been stored in the enhancement information 406d, the EPG application 130 initiates a screen update function. Specifically, the EPG application updates the entry “Winter Olympic Games. Super Giant Slalom” 224 by removing “SCHIFFERER, Andreas” 228 and substituting it with “EBERHARTER, Stephen” 228B, as depicted in FIG. 2B which represents an updated enhanced electronic programming guide 200B. Effectively, if the subscriber 100 browses the enhanced electronic programming guide after the update has been completed, instead of being presented with “SCHIFFERER, Andreas” 228, he or she will be presented with “EBERHARTER, Stephen” 228B which reflects the then current state of the programming event occurring on the channel associated with the channel slot 218.
The EPG application 130 then once again proceeds to step 640. If no termination event has been encountered (i.e. the “NO” branch of step 640), the EPG application 130 will once again loop back to step 620 where it continues to monitor for another dynamic programming information pertaining to the particular programming event. Provided that the content provider 102 has distributed an enhancement token 500D that contains an event identifier 502D pointing to the channel slot 218 and a dynamic program description 504D containing “AAMODT, Kjetil Andre” 228C, denoting the then current competitor in the sporting event being broadcast on the channel associated with the channel slot 218. By executing substantially the same functions as described above with reference to the enhancement token 500C, the EPG application 130 generates an enhanced electronic programming guide screen 200C depicted in FIG. 2C, which is substantially similar to the aforementioned enhanced electronic programming guide 200B, but for the entry for the ‘Winter Olympic Games. Super Giant Slalom” 224 which contains “AAMODT, Kjetil Andre” 228C.

Therefore, it should be clear that if the subscriber 100 invokes the enhanced electronic programming guide at different points within the occurrence interval of a particular programming event (such that the subscriber 100 is presented with the enhanced electronic programming guide screen 200A at one point, the enhanced electronic programming guide screen 200B at a subsequent point and the enhanced electronic programming guide screen 200C at another subsequent point) or if the subscriber 100 expresses his or her desire to view the enhanced electronic programming guide without invoking the aforementioned termination event thereafter, the subscriber 100 will be able to view dynamically updated information that reflects the then current and/or the upcoming status of the particular programming event. Put another way, the enhanced electronic programming guide contemplated herein will be updated with the dynamic program description as it becomes available (i.e., as one or more of the enhancements token 500A, 500B, 500C or 500D are received by the subscriber premises device 104) without the need for the subscriber 100 to explicitly request the update.

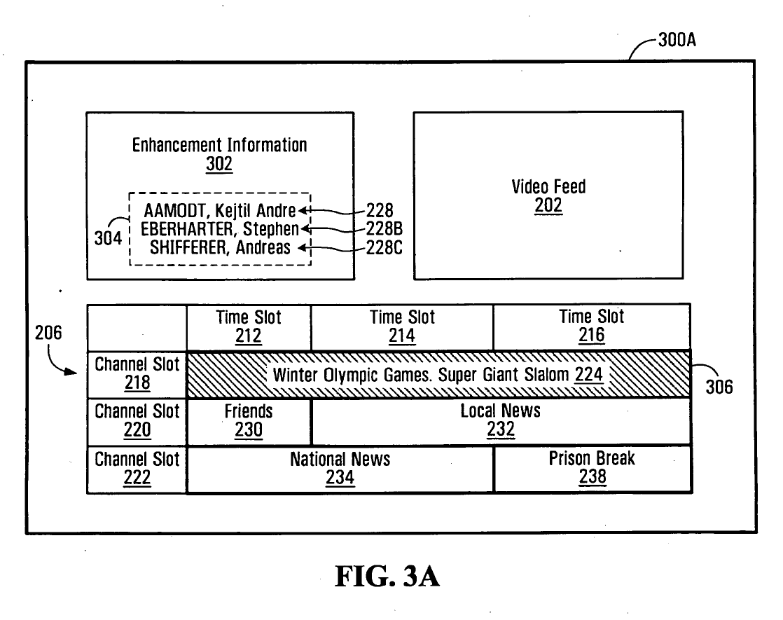

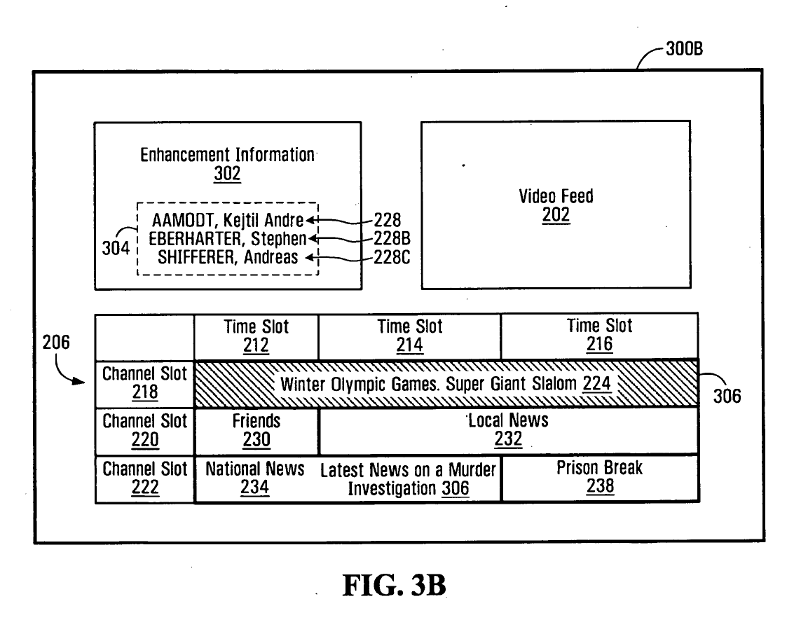

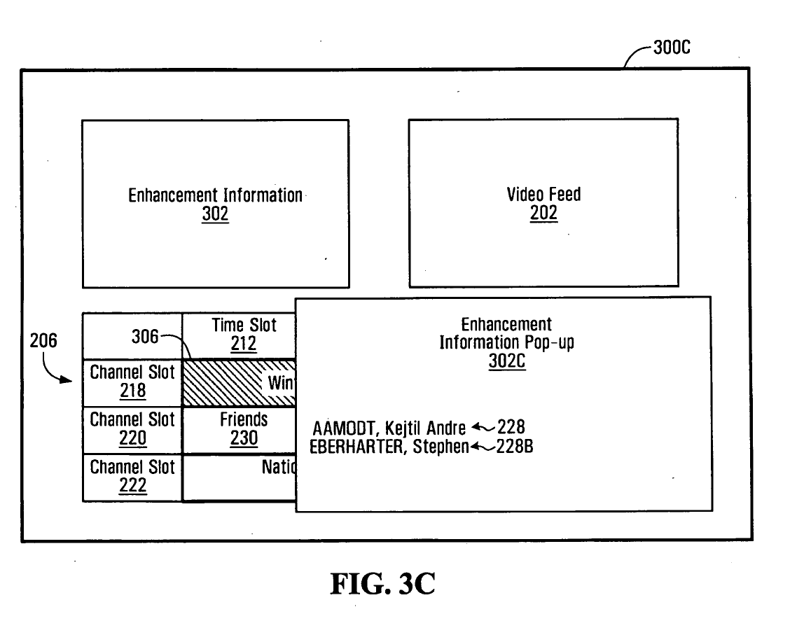

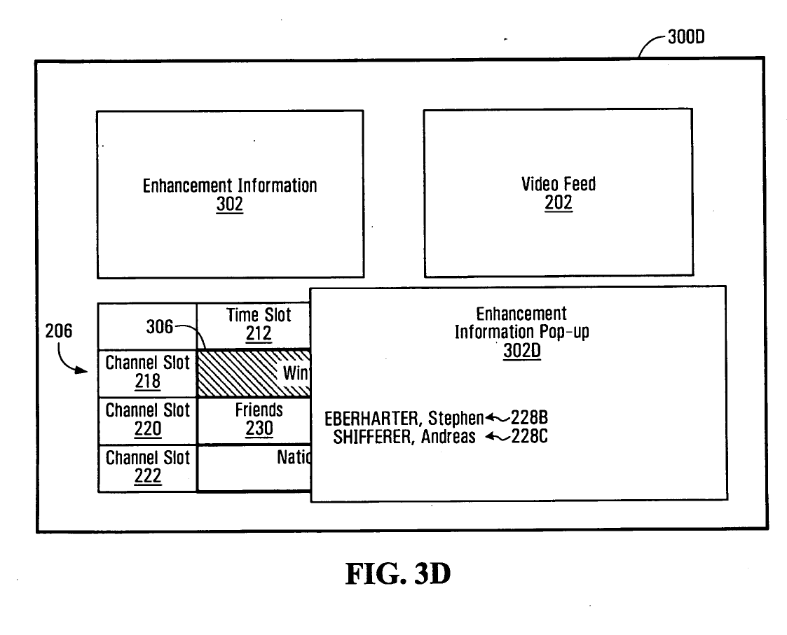

With reference to FIGS. 3A-3D, alternative non-limiting embodiments for how the EPG application 130 can compile the enhanced electronic programming guide will now be discussed. An enhanced electronic programming guide screen 300A of FIG. 3A is substantially similar to the enhanced electronic programming guide screens 200A-200C described above and, therefore, only specific differences will be discussed here. In this embodiment, an enhancement information 302 is used to present the enhanced information 304 associated with a programming event occurring on a so-called “currently selected channel”. The subscriber 100 identifies the currently selected channel by scrolling down through a list of available channels in a manner well known in the art, for example by using “up” and “down” buttons of the aforementioned control device 150. In FIG. 3A, the currently selected channel is denoted by shadowing the respective entry in the basic programming grid information 206, denoted generally at 306, but this need not be so in every embodiment. Other alternative means for denoting the currently selected channel will become apparent to those of skill in the art, such as providing a border around the channel slot associated with the currently selected channel (such as channel slot 218), changing color of the font, changing the size of the font and the like. It should now be apparent that by scrolling through the list of available channels (or in other words by changing the currently selected channel), the subscriber 100 is able to obtain the enhanced information 304 displayed in the enhancement information 302 window (provided that enhancement information is stored in the respective enhancement information 406d, 408d). This would enable the subscriber 100 to make a more informed decision as to which specific programming event to choose for viewing.

An enhanced electronic programming guide screen 300B of FIG. 3B is substantially similar to the enhanced electronic programming guide screen 300A described above and, therefore, only specific differences will be discussed here. The enhanced information 304 associated with the currently selected channel (i.e. the channel associated with the channel slot 218) is displayed in the enhancement information 302, while enhanced information for channels other than the currently selected channel (i.e. the channel associated with the channel slot 222) is displayed within the basic programming grid information 206.

An enhanced electronic programming guide screen 300C if FIG. 3C is substantially similar to the enhanced electronic programming guide screen 300A described above and, therefore, only specific differences will be discussed here. The enhanced information associated with the currently selected channel is displayed in an enhancement information pop-up 302C window which is overlaid over a portion of the basic programming grid information 206. Various functions for creating and displaying such the enhancement information pop-up 302C window would become apparent to those of skill in the art. It should be noted that the size of the enhancement information 302C window in relation to other aspects of the enhanced electronic programming guide 300C is not limiting and, therefore, the enhancement information pop-up 302C window can be overlaid over portions of the basic programming grid information 206, the video feed 202 window and the content provider information 204. The enhancement information pop-up 302C window can be displayed when the subscriber 100 changes the currently selected channel (for instance, moves the selection from the programming event associated with the channel slot 218 to the programming event associated with the channel slot 222). Alternatively, the enhancement information pop-up 302C window can be displayed upon the subscriber 100 indicating his or her desire to view the enhanced information associated with the programming event occurring in the currently selected channel by clicking a dedicated button on the aforementioned control device 150.

In the specific non-limiting embodiment described with reference to FIG. 3C, the enhancement information pop-up 302C conveys to the subscriber 100 two potential example aspects of the enhancement information: (i) information associated with the current competitor (ex. “AAMODT, Kjetil Andre” 228); and (ii) information associated with the next competitor to compete (ex. “EBERHARTER, Stephen” 228B) in the programming event occurring on a channel associated with the currently selected channel (i.e. channel slot 218). As the occurrence interval progresses, provided the subscriber 100 has not invoked the aforementioned termination event and provided that the content provider 102 has distributed the aforementioned enhancement token 500C, the EPG application 130 will invoke the screen update function (as previously described) and will substitute “AAMODT, Kjetil” 228 with “SCHIFFERER, Andreas” 228C, as further depicted in FIG. 3D, which illustrates an enhancement electronic programming guide screen 300D with the updated enhancement information pop-up 302D. The electronic programming guide screen 300D more accurately depicts the then current status of the programming event it pertain to. Specifically, it depicts the then current status as follows: (i) information associated with the then current competitor (ex. “EBERHARTER, Stephen” 228B); and (ii) information associated with the then next competitor to compete (ex. “SCHIFFERER, Andreas” 228C).

Generally speaking, the type of the dynamic program description 504 should not be construed as limiting in any sense and will generally depend on the type of dynamic program description 504 that can be either obtained or generated by the content provider 102.

Even though the foregoing description has mainly made references to two types of programming events (i.e. a sporting event and a news program), it will be apparent to those skilled in the art that teachings of the embodiments of this invention can be applied to other types of programming events. For example, the dynamic programming information can identify when a commercial break is occurring in a particular programming event or even the type of commercial (ex. a commercial for Ford®) occurring in the particular programming event. In another non-limiting example, the dynamic programming information can pertain to a performer currently performing in the American Idol competition. Yet in another non-limiting example, the dynamic programming information can pertain to a nominee currently being awarded with the Academy Award or to an Award category currently being presented. Yet further alternatives will become apparent to those of skill in the art having benefit of the teachings of the embodiments of the present invention.

Persons skilled in the art will appreciate that there are yet more alternative implementations and modifications possible for implementing the present invention, and that the above implementations and examples are only illustrations of one or more embodiments of the present invention. The scope of the invention, therefore, is only to be limited by the claims appended hereto.

What is claimed is:

1. A method for delivering enhanced programming information, the method comprising:
obtaining channel grid information for identifying a programming event, said programming event associated to an occurrence interval;
receiving a dynamic program description associated with said programming event, said receiving occurring during said occurrence interval associated to said programming event;
augmenting said channel grid information with said dynamic program description.

2. The method as defined in claim 1, said dynamic program description comprising a first dynamic program description, the method further comprising:
receiving a second dynamic program description associated with said programming event; said receiving a second dynamic program description occurring during said occurrence interval associated to said programming event subsequently to receipt of said dynamic program description;
replacing said first dynamic program description with said second dynamic program description.

3. The method as defined in claim 1, wherein said augmenting comprises storing said dynamic programming information in association with said channel grid information.

4. The method as defined in claim 1, wherein said augmenting comprises:
substituting a portion of the channel grid information containing a static synopsis with said dynamic programming information.

5. The method as defined in claim 1, wherein said augmenting comprises:
storing said dynamic programming information in addition to data stored in a portion of the channel grid information containing a static synopsis.

6. The method as defined in claim 1, further comprising:
conveying said augmented channel grid information via a television screen.

7. The method as defined in claim 6, wherein said conveying said augmented channel grid information comprises:
displaying said channel grid information on a first portion of the television screen;
displaying said dynamic program description on a second portion of the television screen.

8. The method as defined in claim 7, wherein said second portion of the television screen is within said first portion of the television screen.

9. The method as defined in claim 7, wherein said conveying said augmented channel grid information further comprises overlaying said second portion over at least a portion of said first portion.

10. The method as defined in claim 9, wherein said displaying said dynamic program description is executed upon receiving an indication of a subscriber's desire to view said dynamic program description.

11. The method as defined in claim 1, wherein said channel grid information comprises an indication of said occurrence interval associated to said programming event.

12. The method as defined in claim 11, wherein said channel grid information further comprises a channel identifier and a title associated with said programming event.

13. The method as defined in claim 1, wherein said channel grid information comprises at least an indication of a channel, a title, a start time and a duration associated with said programming event; said start time and said duration jointly defining said occurrence interval associated to said programming event.

14. The method as defined in claim 1, wherein said obtaining comprises:
receiving said channel grid information from a content provider;
storing said channel grid information in a memory.

15. The method as defined in claim 14, wherein said receiving said channel grid information comprises receiving said channel grid information via a distribution network, said distribution network used for distributing said programming event.

16. The method as defined in claim 14, wherein said receiving said channel grid information comprises receiving said channel grid information via a communication network different from a distribution network used for distributing said programming event.

17. The method as defined in claim 14, wherein said augmenting comprises storing said dynamic program description in said memory.

18. The method as defined in claim 1, wherein said receiving a dynamic program description associated with said programming event comprises:
receiving said dynamic program description associated with said programming event via a distribution network, said distribution network used for distributing said programming event.

19. The method as defined in claim 1, wherein said receiving a dynamic program description associated with said programming event comprises:
receiving said dynamic program description associated with said programming event via a communication network different from a distribution network used for distributing said programming event.

20. The method as defined in claim 1, the programming event comprising a sporting event associated with a competitor currently competing; wherein the dynamic program description identifies the competitor currently competing in the sporting event.

21. The method as defined in claim 1, the programming event comprising a sporting event associated with a current score; wherein the dynamic program description identifies the current score.

22. The method as defined in claim 1, the programming event comprising a sporting event associated with a current period; wherein the dynamic program description identifies the current period.

23. The method as defined in claim 1, the programming event comprising a news program associated with a news segment; wherein the dynamic program description identifies the news segment currently occurring in the news program.

24. The method as defined in claim 1, wherein the dynamic program description identifies a programming segment currently occurring in the programming event.

25. The method as defined in claim 24, wherein the programming segment comprises a commercial.

26. An interactive application residing on a customer premises device, the interactive application being operable to execute the method as defined in claim 1.

27. A method for enabling delivery of enhanced programming information, the method comprising:
transmitting channel grid information to a subscriber premises device for identifying a programming event;
transmitting a dynamic program description associated with said programming event to said subscriber premises device during an occurrence interval associated to said programming event; said dynamic program description enabling said subscriber premises device to augment said channel grid information with said dynamic program description.

28. The method as defined in claim 27, said dynamic program description comprising a first dynamic programming information, the method further comprising:
transmitting a second dynamic program description to said subscriber premises device during said occurrence interval associated to said programming event subsequently to transmitting said first dynamic program description; said second dynamic program description enabling the customer premises device to replace said first dynamic program description with said second dynamic program description.

29. The method as defined in claim 27, further comprising, prior to transmitting said dynamic program description:
obtaining data representative of said dynamic program description; and
generating said dynamic program description based on said data representative of said dynamic program description.

30. The method as defined in claim 29, wherein said generating said dynamic program description comprises encapsulating data representative of said dynamic program description into a delivery component, said delivery component suitable for delivery over a distribution network, said distribution network used for distributing said programming event.

31. The method as defined in claim 30, further comprising assigning an identifier to said delivery component, said identifier uniquely identifying said programming event.

32. The method as defined in claim 30, the distribution network comprising a satellite distribution network, wherein said encapsulating comprises transmitting said delivery component to a broadcast carousel.

33. The method as defined in claim 30, the distribution network comprising a data network adapted for video transmission, wherein said encapsulating comprises packetizing said delivery component.

34. The method as defined in claim 30, wherein said generating said dynamic program description comprises encapsulating data representative of said dynamic program description into a delivery component, said delivery component suitable for delivery over a communication network different from a distribution network used for distributing said programming event.

35. A system for delivery of enhanced programming information, the system comprising:
at least one subscriber premises device;
a content provider operable to:
transmit channel grid information to said at least one subscriber premises device for identifying a programming event;
transmit during an occurrence interval associated to said programming event a dynamic program description associated with said programming event to said at least one subscriber premises device,
wherein responsive to receiving said dynamic program description, the at least one subscriber premises device is operable to augment said channel grid information with said dynamic program description.

36. The system as defined in claim 35, further comprising a distribution network interconnecting said content provider and said at least one subscriber premises device.

37. The system recited in claim 36, wherein said distribution network comprises one of a satellite distribution network, a cable network, a data network adapted for video transmission and an xDSL network.

38. The system as defined in claim 36, wherein said distribution network is used for distributing:
a signal representative of said programming event;
said channel grid information; and
said dynamic program description.

39. The system as defined in claim 36, further comprising a communication network interconnecting said content provider and said at least one subscriber premises device.

40. The system as defined in claim 39, wherein:
said distribution network is used for distributing a signal representing said programming event and said channel grid information; and
said communication network is used for distributing said dynamic program description.

41. The system as defined in claim 39, wherein:
said distribution network is used for distributing a signal representing said programming event; and
said communication network is used for distributing said channel grid information and said dynamic program description.

42. The system as defined in claim 39, wherein:
said distribution network is used for distributing a signal representing said programming event and said dynamic program description; and
said communication network is used for distributing said channel grid information.

43. A customer premises apparatus, comprising:
a first interface for receiving a signal from a content provider;
a second interface for conveying an output signal derived from the received signal to an audio-video output device;
a processing module coupled to said first and second interfaces, the processing apparatus operable to:
obtain via said first interface channel grid information for identifying a programming event;
receive via said first interface during an occurrence interval associated to said programming event a dynamic program description associated with said programming event;
augment said channel grid information with said dynamic program description.

44. The customer premises apparatus as defined in claim 43, wherein said processing module is further operable to convey said augmented channel grid information via said second interface.

45. The customer premises apparatus as defined in claim 44, further comprising a third interface for receiving a signal from a control device; wherein the processing module is further operable to convey said augmented channel grid information only in response to receipt of a signal from the control device indicative of a subscriber's desire to view said augmented channel grid information.

46. The customer premises apparatus as defined in claim 43, further comprising a memory for storing said channel grid information and said augmented channel grid information.

47. The customer premises apparatus as defined in claim 46, wherein said memory comprises an interactive application accessible by the processing apparatus; and wherein to augment said channel grid information with said dynamic program description, the processing apparatus is operable to initiate execution of said interactive application.

48. An apparatus for enabling delivery of enhanced programming information, the apparatus comprising:
means for transmitting channel grid information to a subscriber premises device for identifying a programming event;
means for transmitting a dynamic program description associated to said programming event to said subscriber premises device during an occurrence interval associated to said programming event; said dynamic program description enabling said subscriber premises device to augment said channel grid information with said dynamic program description.

49. The apparatus as defined in claim 48, wherein said means for transmitting channel grid information and said means for transmitting a dynamic program description are implemented in a real time injection module operable to transmit a signal via a distribution network coupled to said apparatus.

50. The apparatus as defined in claim 48, further comprising content acquiring means for obtaining data representative of said dynamic program description prior to transmittal thereof to said subscriber premises device.

51. The apparatus as defined in claim 50, further comprising a programming information means for generating said dynamic program description based on said data representative of said dynamic program description.
